(19) United States
(12) Patent Application Publication
(10) Pub. No.: US 2005/0242791 A1
(43) Pub. Date: Nov. 3, 2005

(54) High-speed, dual-loop push-pull voltage regulator

(75) Inventors: Saravanan Rajapandian, New York, NY (US); Peter Hazucha, Beaverton, OR (US); Tanay Karnik, Portland, OR (US)

Correspondence Address: FLESHNER & KIM, LLP, P.O. BOX 221200, CHANTILLY, VA, 20153, US

(73) Assignee: Intel Corporation

(21) Appl. No.: 10/835,066

(22) Filed: Apr. 30, 2004

(51) Int. Cl. G05F 1/40

(52) U.S. Cl. 323/268

(57) ABSTRACT

A series voltage regulator circuit includes first and second voltage regulators, a first controller to control an output voltage of the first voltage regulator, and a second controller to control an output voltage of the second voltage regulator. The voltage regulators preferably include internal control loops which rapidly respond to the load variations, however the controllers operate independently from these variations. By isolating the controllers from the load, the controllers are able to maintain the output of the regulators at a constant value. In one embodiment, the voltage regulators are connected in a push-pull configuration for driving the load.

### FIELD

This invention relates to voltage regulation.

### BACKGROUND

An integrated circuit chip, such as a microprocessor, often requires multiple supply voltages for different parts of the chip circuit. This may reduce power consumption of components that can utilize a lower voltage than the other portions of the chip. A main supply voltage may be provided to the chip from an off-chip source, and an on-chip power converter may be used to generate additional supply voltages from the main supply voltage. When the main supply voltage from an off-chip source is the highest of the supply voltages used in the chip, a “series voltage regulator” may be used to obtain the other supply voltages that are lower than the main supply voltage.

FIG. 1 shows a conceptual model of a series voltage regulator that includes a controllable series resistor R₁ connected between a main power supply and an output node Nₒᵤₜ. For a constant load current I_{load}, the value of R₁ may be constant. However, if the load changes over time, a feedback circuit that includes a differential amplifier DA connected to a reference voltage V_{R} may be used to dynamically adjust the value of the resistor in order to keep the output voltage V_{O} substantially constant. The reference voltage may be generated using a band-gap reference circuit that produces a constant voltage independent of operating temperature, input supply voltage and processing conditions. Also, a second resistor R₂ may be connected between the output node and ground to achieve better control of the output voltage.

### BRIEF DESCRIPTION OF THE DRAWINGS

FIG. 1 is a diagram showing a conventional series voltage regulator.

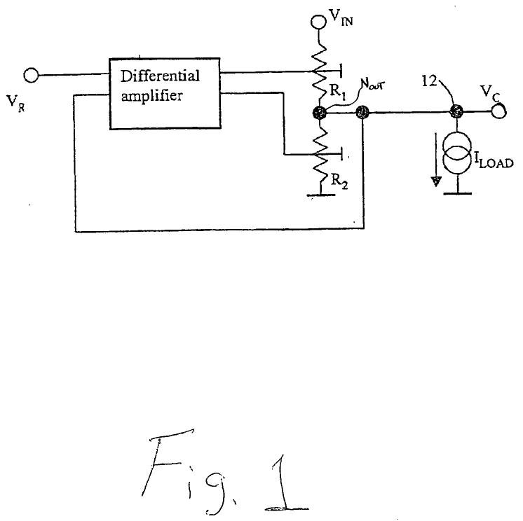

FIG. 2 is a diagram showing a dual-loop, push-pull voltage regulator in accordance with one embodiment of the present invention.

FIG. 3 is a diagram showing an example of a transistor-level implementation of the voltage regulator of FIG. 2.

FIG. 4 is a diagram showing a dual-loop, push-pull voltage regulator in accordance with another embodiment of the present invention.

FIG. 5 is a diagram showing an example of a transistor-level implementation of the voltage regulator of FIG. 4.

FIG. 6 is a diagram showing how a voltage regulator in accordance with any of the embodiment of the present invention may be used for performing a voltage scaling operation.

FIG. 7 is a flow diagram showing functional blocks included in a method for relating voltage in accordance with one embodiment of the present invention.

FIG. 8 is a diagram showing a processing system in accordance with an embodiment of the present invention.

### DESCRIPTION OF THE PREFERRED EMBODIMENTS

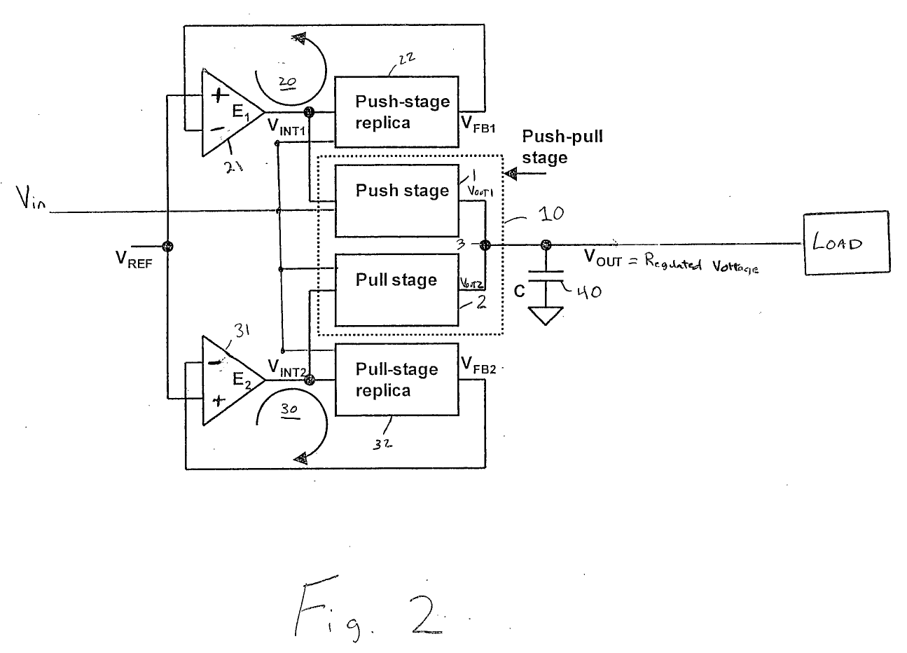

FIG. 2 shows a dual-loop, push-pull voltage regulator in accordance with one embodiment of the present invention. This voltage regulator includes a push-pull output stage 10 and two feedback control loops 20 and 30. The push and pull stages are both preferably low-impedance stages. Also, in this embodiment, the push and pull stages are non-inverting, i.e., DC gain from V_{INT1} to V_{OUT1} and from V_{INT2} to V_{OUT2} is positive. The gain may be negative in other embodiments.

The output stage includes a push stage 1 and a pull stage 2 coupled to a common node 3. This node, in turn, is optionally connected to a decoupling capacitor 40 which may be used to filter signals from the output stage when, for example, load variations occur. The signal from the capacitor node corresponds to the regulated voltage V_{OUT}, which is substantially equal to a reference voltage V_{REF} by virtue of the feedback control loops. In this embodiment, V_{REF} may be a predetermined fraction of an input voltage Vᵢₙ and is supplied to the control loops to maintain stable operation of the voltage regulator. As will be explained in greater detail below, in accordance with at least one embodiment the control loops correct for temperature, manufacturing, and input supply variations to ensure that V_{OUT}=V_{REF} at all times. Thus, while V_{OUT}=V_{REF}, V_{OUT} also preferably equals a predetermined or adjustable fraction of Vᵢₙ; that is, the value of V_{REF} may be used as a basis for setting the fractional output of Vᵢₙ, i.e., V_{OUT}=V_{REF}=1/N·Vᵢₙ with N preferably being an integer.

Feedback control loop 20 includes a differential amplifier 21 and a replica 22 of the push stage in the output stage. The differential amplifier has a non-inverting terminal coupled to receive the reference voltage V_{REF} and an inverting terminal coupled to an output of the push-stage replica. The amplifier (alternatively labeled E₁) subtracts the output of the push-stage replica, labeled V_{FB1}, from the reference voltage and outputs a signal proportional to the error voltage (V_{FB1}−V_{REF}), multiplied by negative gain of E₁. A positive error results in smaller V_{INT1}, which would reduce V_{FB1} and reduce the error. This error or difference signal V_{INT1} (also referred to as an internal reference voltage) drives both the push-stage and push-stage replica to ensure that their outputs, V_{FB1} and V_{OUT1}, equal V_{REF} when V_{OUT1} is not loaded. When V_{OUT1} is loaded by current, a difference will exist between V_{FB1} and V_{OUT1} which causes V_{OUT1} to deviate from V_{REF}. But since the push stage is designed to have low output impedance, the difference should be small.

In an alternative embodiment, a voltage divider circuit may be connected to the output of stage 22 so that the inverting-input voltage of amplifier El equals some predetermined fraction of V_{FB1}. Such a voltage divider circuit may be formed, for example, from two series-connected resistors where a node between the resistors is coupled to the output of the push stage. In this instance, V_{FB1} (and V_{OUT}) would equal to V_{REF} multiplied by (R1+R2)/R2, which would equal still another predetermined fraction of Vᵢₙ.

Feedback control loop 30 includes a differential amplifier 31 and a replica 32 of the pull stage in the output stage. The differential amplifier has a non-inverting terminal coupled to receive the reference voltage V_{REF} and an inverting terminal coupled to an output of the pull-stage replica. The amplifier (alternatively labeled E₂) subtracts the output of the pull-stage replica, labeled V_{FB2}, from the reference voltage and outputs a signal proportional to the error voltage (V_{FB2}−V_{REF}), multiplied by negative gain of E₂. A positive error results in smaller V_{INT2}, which would reduce V_{FB2} and reduce the error. This error or difference signal V_{INT2} (also referred to as an internal reference voltage) drives both the pull-stage and pull-stage replica to ensure that their outputs, V_{FB2} and V_{OUT2}, equal V_{REF} when V_{OUT2} is not loaded. When V_{OUT2} is loaded by current, there will be a difference between V_{FB2} and V_{OUT2} which causes V_{OUT2} to deviate from V_{REF}. But since the push stage is designed to have low output impedance, the difference should be small.

In an alternative embodiment a voltage divider circuit may be connected to the output of stage 32 so that the inverting-input voltage of amplifier E₂ equals some predetermined fraction of V_{FB2}. Such a voltage divider circuit may be formed, for example, from two series-connected resistors where a node between the resistors is coupled to the output of the push stage. In this instance, V_{FB2} (and V_{OUT}) would equal to V_{REF} multiplied by (R1+R2)/R2, which would equal still another predetermined fraction of Vᵢₙ.

As previously mentioned, the output voltages of the push and pull stages in the output stage are set by V_{INT1} and V_{INT2} respectively. Functionally, the push-stage operates to supply current to the output node and the pull stage operates to sink current from this node. Cross-over current may be prevented by replica-biasing each of the stages separately. The differential amplifiers in the feedback loops set the unloaded outputs of the push and pull replica stages to predetermined values. These values are preferably set so that V_{FB1}=V_{FB2}=V_{REF}.

Also, in FIG. 2 the push- and pull-stage replicas are preferably matched to respective stages in the output stage. When matched in this manner, the stages may advantageously produce the same output voltage and the cross-over current flowing from the push-stage output into the pull-stage output is nearly zero. Any mismatch between the feedback voltage V_{FB1} and V_{FB2} or between the push and pull stages and their replicas may cause a cross-over current proportional to the voltage mismatch. This mismatch can be reduced or eliminated by proper sizing and a matched layout design.

In operation, when positive current is drawn out from V_{OUT}, the pull stage is nearly off and a fast feedback loop built into the push stage acts to supply current to V_{OUT}. When negative current is drawn out from V_{OUT}, the push stage is nearly off and a fast feedback loop built into the pull stage acts to sink current from V_{OUT}. In this scheme, error amplifiers E₁ and E₂ do not act upon the variations in V_{OUT} caused by the load current because voltages V_{FB1} and V_{FB2} do not vary with a load connected to the output of the voltage regulator. As a result, feedback loops 20 and 30 are not required to have high bandwidth.

The FIG. 2 voltage regulator is therefore able to achieve a number of significant advantages over other circuit arrangements which have been proposed. This regulator, for example, provides a controlled quiescent current while simultaneously consuming a relatively small silicon area compared with other voltage regulation schemes. Also, the FIG. 2 circuit performs very fast load regulation which is attributable at least in part to generating V_{OUT} in a way which avoids a direct use of operational amplifiers along its signal path, which amplifiers have been shown to significantly slow response time of conventional circuits.

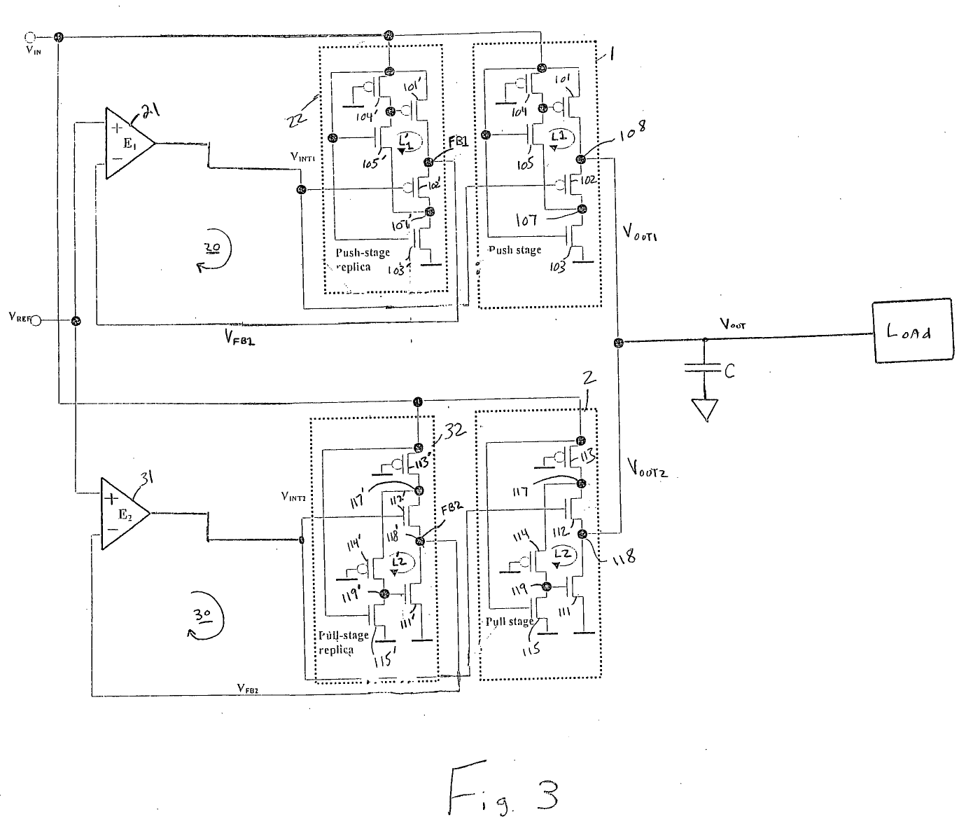

FIG. 3 shows an example of a transistor-level implementation of the series voltage regulator of FIG. 2. Push stage 1 includes P-channel driving transistors 101 (connected in a common-drain configuration) and 102 (connected in a common-gate configuration). An N-channel transistor 103 operates as a pull-down current source and sets the quiescent current of the circuit.

Transistor 104 functions as a pull-up current source. To ensure proper operation, this current is preferably less than the current provided by transistor 103. The gate of transistor 102 is connected to internal DC reference voltage V_{INT1} output from error amplifier 21. As previously mentioned, V_{INT1} serves as setting voltage so that V_{OUT1}=V_{REF} under unloaded condition. When operating in steady state, the output voltage V_{OUT1} settles to a constant value approximately equal to V_{INT1}+V_{T1}, where V_{T1} is the threshold voltage of transistor 102. By virtue of matching between the push stage and push-stage replica and feedback loop 20, V_{OUT1}=V_{FB1}=V_{REF}. When positive current is drawn from V_{OUT1}, this will cause V_{OUT1} to reduce below its unloaded value. This voltage droop is amplified by transistor 102 acting as a common gate amplifier causing voltage on node 107 to decrease. This turns on transistor 105 that acts as another common gate amplifier and pulls the gate of the output driver transistor 101 low. This results in transistor 101 turning on and supplying larger current to V_{OUT1}, thereby compensating for the voltage drop and increased loading on V_{OUT1}.

The gates of transistors 103 and 105 are connected to an input voltage Vᵢₙ that, for example, may correspond to a supply voltage generated by an on- or off-die voltage source. Vᵢₙ is also connected to the source of transistor 104 for purposes of generating current for the feedback loop. The gate of transistor 104 is connected to a bias voltage which may be a reference potential, e.g., ground. The regulated voltage output from push stage 1 emanates from a node 108 between transistors 101 and 102 and is illustratively shown as V_{OUT1}. While the connections in FIG. 3 are preferable for purposes of reducing circuit complexity, alternative embodiments may couple the gate of transistor 104 to a DC bias voltage which is different from ground. Also, the gates of transistors 103 and 105 may be coupled to bias voltages that are different from the input reference voltage Vᵢₙ.

The push stage thus has a fast internal feedback loop (arrow L₁) that allows the push stage to rapidly adjust its output current in response to fast load changes, i.e., the push stage adjusts the output current so that the V_{OUT1} voltage remains substantially constant relative to V_{INT1} output from amplifier E₁.

Feedback loop 20 maintains the internal reference voltage V_{INT1} at a predetermined value when variations in V_{FB1} occur. Preferably, V_{INT1} is controlled by the feedback loop to maintain a value of V_{FB1} and unloaded value of V_{OUT1} equal to or based on V_{REF}. To achieve this level of control, push-stage replica 22 may have a structure identical to push-stage 1 except that its output node (V_{FB1} ) is fed back to the non-inverting terminal of error amplifier 21.

Feedback loop 20 thus maintains the input reference voltage at a predetermined value, thereby stabilizing operation of the push stage. Also, amplifier E₁ does not respond to variations in V_{OUT1} (and also V_{OUT}) caused by load current changes. As a result, voltage V_{FB1} will not vary with the load and thus feedback loop 20 does not require high bandwidth and may have a slow response time.

Pull stage 2 includes N-channel driving transistors 111 (connected in a common-drain configuration) and 112 (connected in a common-gate configuration). A P-channel transistor 113 operates as a pull-up current source and sets the quiescent current of the circuit.

Transistor 115 functions as a pull-down current source. To ensure proper operation, this current is preferably less than the current provided by transistor 113. The gate of transistor 112 is connected to internal DC reference voltage V_{INT2} output from error amplifier 31. As previously mentioned, V_{INT2} serves as setting voltage so that V_{OUT2}=V_{REF} under unloaded condition. When operating in steady state, the output voltage V_{OUT2} settles to a constant value approximately equal to V_{INT2}−V_{T2}, where V_{T2} is the threshold voltage of transistor 112. By virtue of matching between the pull stage and pull-stage replica and feedback loop 30, V_{OUT2}=V_{FB2}=V_{REF}. When negative current is drawn from V_{OUT2}, this will cause V_{OUT2} to rise above its unloaded value. This voltage rise is amplified by transistor 112 acting as a common gate amplifier causing voltage on node 117 to rise. This turns on transistor 114 that acts as another common gate amplifier and pulls the gate of the output driver transistor 111 high. This results in transistor 111 turning on and supplying larger negative current to V_{OUT2} (i.e. sinking positive current from V_{OUT2}), thereby compensating for the voltage rise and increased loading on V_{OUT2}.

The gates of transistors 113 and 114 are connected to a reference potential, e.g., ground. Ground is also connected to the source of transistor 115 for purposes of generating current for the feedback loop. The gate of transistor 115 is connected to a bias voltage which may be an input voltage Vᵢₙ which, for example, may correspond to a supply voltage generated by an on- or off-die voltage source. The regulated voltage output from pull stage 2 emanates from a node 118 between transistors 111 and 112 and is illustratively shown as V_{OUT2}. While the connections in FIG. 3 are preferable for purposes of reducing circuit complexity, alternative embodiments may couple the gate of transistor 115 to a DC bias voltage which is different from voltage Vᵢₙ. Also, the gates of transistors 113 and 114 may be coupled to bias voltages that are different from the reference potential, e.g. ground.

The pull stage thus has a fast internal feedback loop (arrow L₂) that allows the pull stage to rapidly adjust its output current in response to fast load changes, i.e., the pull stage adjusts the output current so that V_{OUT2} voltage remains substantially constant relative to V_{INT2} output from amplifier E₂.

Feedback loop 30 maintains the internal reference voltage V_{INT2} at a predetermined value when variations in V_{FB2} occur. Preferably, V_{INT2} is controlled by the feedback loop to maintain a value of V_{FB2} and unloaded value of V_{OUT2} equal to or based on V_{REF}. To achieve this level of control, pull-stage replica 32 may have a structure identical to pull-stage 2 except that its output node (V_{FB2}) is fed back to the non-inverting terminal of error amplifier 31.

Feedback loop 30 thus maintains the input reference voltage at a predetermined value, thereby stabilizing operation of the push stage. Also, amplifier E₂ does not respond to variations in V_{OUT2} (and also V_{OUT}) caused by load current changes. As a result, voltage V_{FB2} will not vary with the load and thus feedback loop 30 does not require high bandwidth and may have a slow response time.

When the load current changes, some output voltage variation may couple via parasitic input-output capacitance to nodes V_{INT1} and V_{INT2}. To prevent this condition, one approach that may be taken involves connecting a decoupling capacitor to these nodes. Another approach involves buffering the outputs of the error amplifiers. This latter approach may be preferable for purposes of minimizing chip area and maintaining stability.

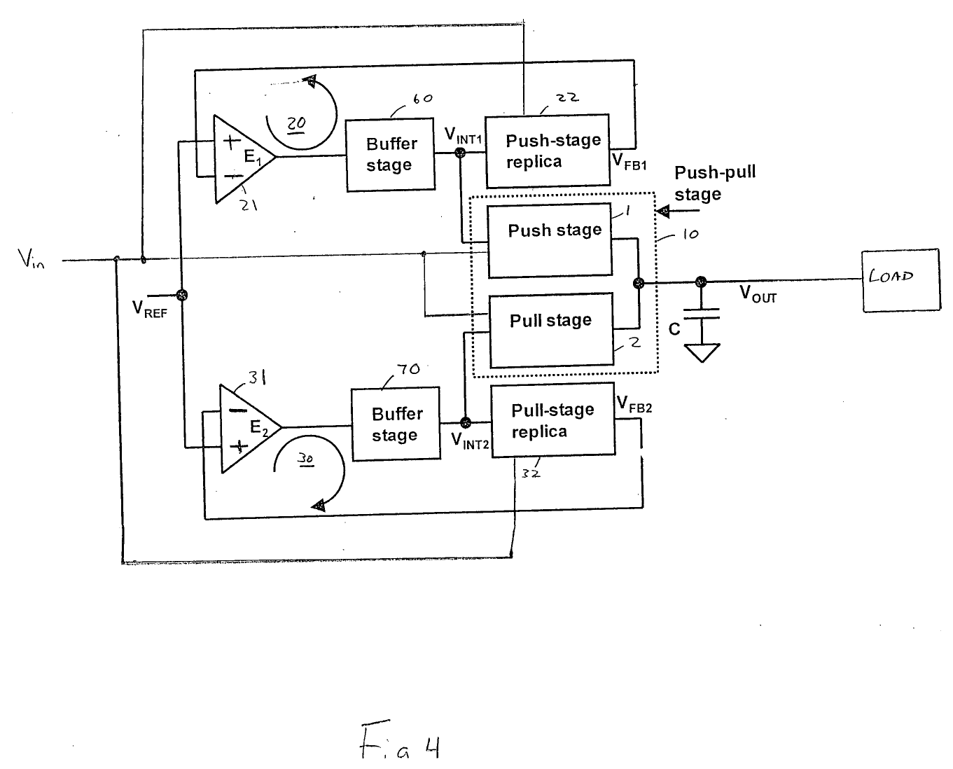

FIG. 4 shows a dual-loop, push-pull voltage regulator in accordance with another embodiment of the present invention. In this embodiment, an example of the aforementioned buffering approach is implemented. More specifically, in FIG. 4 the output stage and feedback loops are the same as in FIG. 2 except that non-inverting buffer stages are included in the feedback loops, i.e., a buffer stage 60 is coupled between error amplifier E₁ and the push-stage replica in loop 20 and a buffer stage 70 is coupled between error amplifier E₂ and the pull-stage replica in loop 30. The buffer stages operate to reduce or eliminate output voltage variation which may be coupled to nodes V_{INT1} and V_{INT2} as a result of parasitic input-output capacitance.

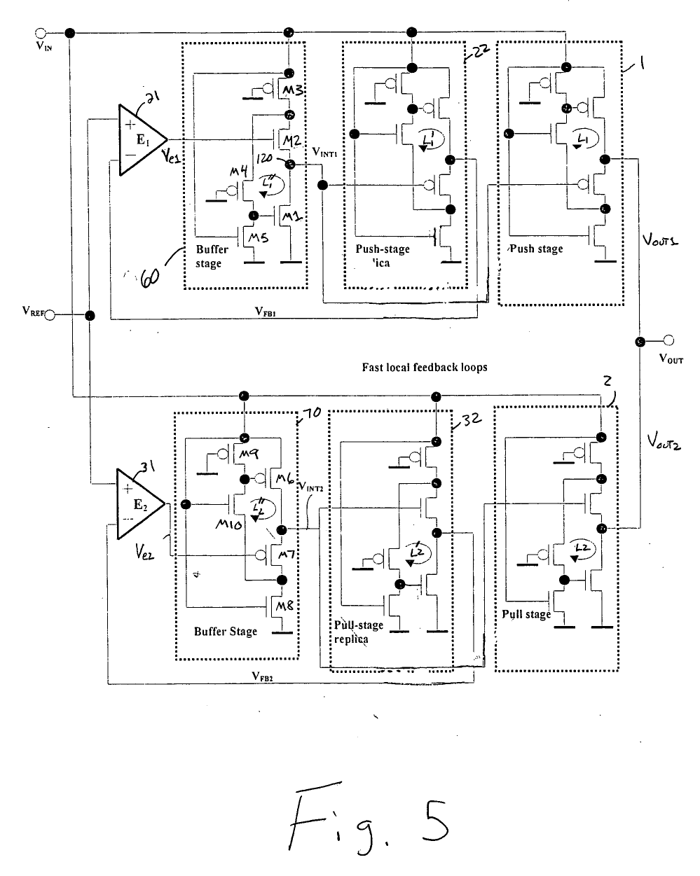

FIG. 5 shows an example of a transistor-level implementation of the voltage regulator of FIG. 4. In this implementation, buffer stage 60 is a low-impedance stage having a configuration similar to the pull stage, i.e., transistors M1-M5 correspond to transistors 111-115 with similar connections. Differences include coupling the gate of transistor M2 to receive the output Vₑ₁ from amplifier E₁ and outputting the internal reference voltage V_{INT1} from node 120 for input into the push stage and push-stage replica circuits. While this arrangement is preferable, other types of circuits may be used to implement buffer stage 60.

Buffer stage 70 is also a low-impedance stage having a configuration similar to the push stage, i.e., transistors M6-M10 correspond to transistors 101-105 with similar connections. Differences include coupling the gate of transistor M7 to receive the output Vₑ₂ from amplifier E₂ and outputting the internal reference voltage V_{INT2} from node 130 for input into the pull stage and pull-stage replica. While this arrangement is preferable, other types of circuits may be used to implement buffer stage 70.

In operation, the push-stage replica generates feedback voltage V_{FB1} for input into the non-inverting terminal of differential amplifier 21. The feedback loop 20 formed by this connection only tracks “zero-load errors” caused by manufacturing process, operating temperature, and power supply variations. The pull-stage replica generates feedback voltage V_{FB2} for input into the non-inverting terminal of differential amplifier 31. Like loop 20, feedback loop 30 only tracks “zero-load errors” caused by manufacturing, operating temperature, and power supply variations. The zero-load errors represent deviations of the output voltage from input reference V_{REF} when there is no load. Depending on the application, the feedback loop may be designed to have low bandwidth and high DC gain.

In FIG. 5, load current changes are tracked by the internal high-speed feedback loop L₁ in the push stage and the internal high-speed feedback loop L₂ in the pull stage. In addition, the push-stage replica has a fast internal feedback loop L₁′ and buffer stage 60 has a fast internal feedback loop L₁″. The internal feedback loops of these stages may be designed to have high-bandwidth which allows the voltage regulator to have low output impedance and fast response to load changes. Moreover, because amplifiers E₁ and E₂ do not respond to variations in V_{OUT1} and V_{OUT2} respectively (because V_{FB1} and V_{FB2} do not vary with load), feedback loops 20 and 30 may have a slow response time and do not require a high bandwidth.

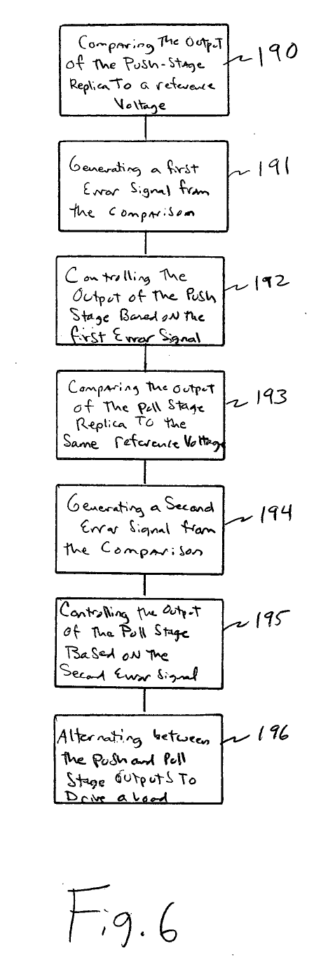

FIG. 6 shows functional blocks included in a method for regulating a voltage for driving a load in accordance with one embodiment of the present invention. Referencing the foregoing embodiments, the driving voltage is regulated by comparing the output of the push stage replica 22 to the reference voltage. (Block 190). The differential amplifier in control loop 20 then generates error signal V_{INT1} from the comparison. (Block 191). The error signal is then used to control the output of the push stage 1 so that V_{OUT1} preferably equals V_{REF}, which represents some predetermined fractional value of input voltage Vᵢₙ, (Block 192). Control loop 20 is isolated from variations of the load and therefore is able to continuously correct the unloaded value of V_{OUT1} to equal its predetermined value. The internal control loop in the push stage replica, however, is able to rapidly respond to the load variations.

On the pull stage side, the output of the pull stage replica 32 is compared to the reference voltage. (Block 193). The differential amplifier in control loop 30 then generates error signal V_{INT2} from the comparison. (Block 194). The error signal is then used to control the output of the pull stage 2 so that V_{OUT2} preferably equals V_{REF}, which preferably represents the same fractional value of input voltage Vᵢₙ. (Block 195). Control loop 30 is isolated from variations of the load and therefore is able to continuously correct V_{OUT1} to equal its predetermined value. The internal control loop in the pull stage replica, however, is able to rapidly respond to the load variations. The voltages output from the push and pull stages are alternated as necessary to drive the load, i.e., the pull stage is activated and the push stage is deactivated when sinking is required and the push stage is activated and the pull stage is deactivated when source current is required. (Block 196).

The embodiments of the present invention may be used in a variety of applications. One application involves performing dynamic voltage scaling for powering circuits. Dynamic (or adaptive) voltage scaling (DVS) offers the ability to trade-off power and performance through adjustment of a supply voltage. Often this supply voltage is higher than is required to meet the supply requirements of many circuits. Through scaling, significant energy savings can be realized by lowering the supply voltage until these performance requirements are met.

Multiple supply voltages can be delivered from an off-chip source, e.g. a VRM. In other embodiments, one or more of these voltages (e.g., an intermediate supply voltage) may be generated on-die. This may reduce currents through the chip package, the cost of decoupling, and provide better droop control. For example, consider the case where intermediate voltage V_{CC}/2 is generated on-die from supply voltage V_{CC} and V_{SS} which may serve as a reference potential. A first portion of the die circuits may be powered by V_{CC} and V_{CC}/2, and a second portion of the die circuits may be powered by V_{CC}/2 and V_{SS}. The regulator thus supplies only the difference of currents drawn by the first and second portions of the die circuits. Other die circuits may operate from the full supply voltages of V_{CC} and V_{SS}. To maintain the intermediate voltage, a voltage regulator in accordance with one or more embodiments of the present invention may source or sink current as necessary in order to steadily provide V_{CC}/2.

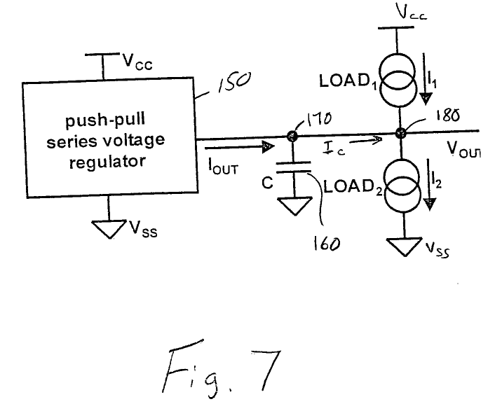

FIG. 7 shows an example of how a voltage regulator in accordance with any of the embodiments of the present invention may be used to perform a voltage scaling function. In this circuit, the voltage regulator 150 is coupled to a decoupling capacitor 160, which, in turn, is coupled to a parallel connection of two loads, Load₁ and Load₂. The regulator generates current I_{OUT} for input into node 170 of the capacitor, which performs a filtering function. The resulting current I_{C} is then input into node 180. The first load is powered from voltage supply voltage V_{CC} and a scaled (regulated) voltage V_{OUT}, and the second load is powered from V_{OUT} and V_{SS} which may correspond to a reference potential. I₁ and I₂ are currents consumed by the loads respectively.

While V_{CC} is connected to both the voltage regulator and Load₁, the power source for these components may be different. Also, the scaled (regulated) voltage V_{OUT} may be V_{CC}/2 or any other fraction of V_{CC} depending upon the intended application. The voltage scaling function of this circuit may be performed on- or off-chip depending on the requirements of an intended application. Also, while voltage scaling is illustratively shown as being implemented in a charge-recycling configuration, other schemes are possible.

Digital circuits (such as those found in microprocessors) draw supply current that may rapidly change between minimum and maximum values. Load current changes faster than the response time of the voltage regulator will be filtered out by the decoupling capacitor. To account for this prospect, the embodiments of the voltage regulator of the present invention may advantageously realize a response time which is short enough to track fast changes in the load variations. By way of illustration, simulations have shown that the voltage regulator may attain a response time of 200 ps, although faster or shorter times are also possible.

This level of performance allows the requirements of the decoupling capacitor to be relaxed, e.g., the size of the capacitor may be substantially reduced. Also, a fast-error amplifier is not required and therefore excellent feedback loop stability may be attained. Further, the voltage regulator can operate using a controlled quiescent current and may be implemented in a small silicon area, all while simultaneously achieving very fast load regulation. As a result, the voltage regulator is ideal for generating regulated voltages (e.g., V_{CC}/2 generation) for circuits with multiple supply domains.

Also, the embodiments of the voltage regulator described herein are suitable for driving high DC as well as high AC currents, and can be used to generate the intermediate voltage (e.g., V_{CC}/2) in any multiple supply voltage environment, as previously discussed. This is beneficial since high power consumption is a main concern in current microprocessors. By reducing the supply voltage by a predetermined fraction (e.g., by half) and by decreasing the clock frequency by half, the embodiments of the present invention are able to significantly reduce dynamic power, e.g., by eight times. Also, leakage power is reduced exponentially.

Also, through this voltage regulator, non-critical digital blocks in a microprocessor could operate, for example, from full supply power V_{CC} to V_{CC}/2, or from V_{CC}/2 and a second potential, e.g., reference supply potential V_{SS}. This will result in a significant reduction in power and input current. The series voltage regulator can also regulate the output voltage to the fractional value (e.g., V_{CC}/2) and supply a worst-case match current, all while minimizing chip area and using a small decoupling capacitance.

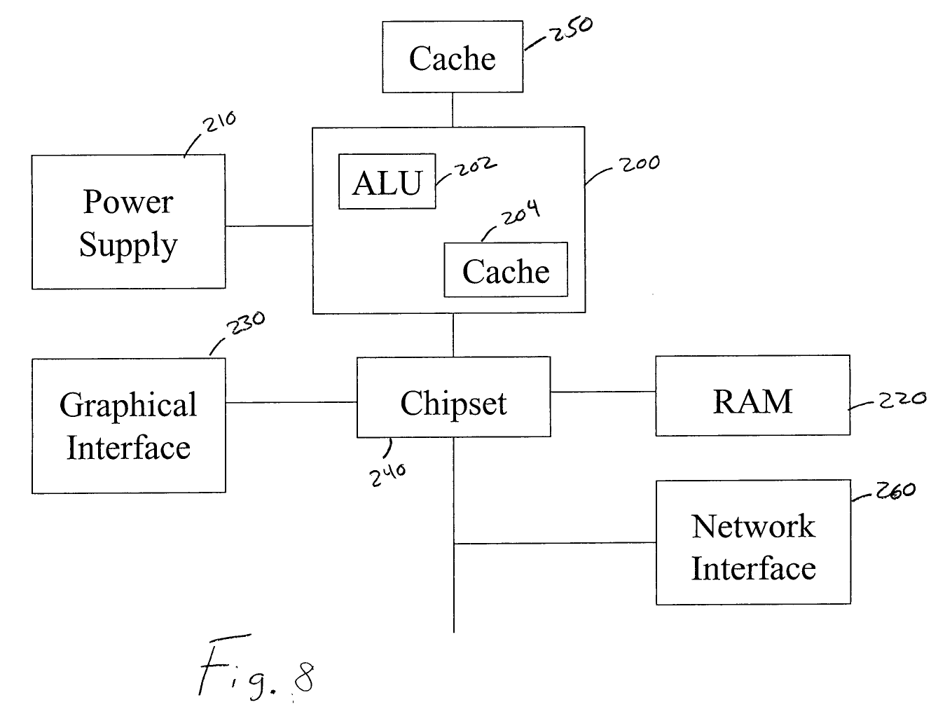

Fig.8 shows a processing system that corresponds to another application of the series voltage regulator. In accordance with one embodiment, the processing system includes a processor 200, a power supply 210, and a memory 220 that, for example, may be a random-access memory. The processor may include an arithmetic logic unit 202 and an internal cache 204. In addition to these elements, the processing system may optionally include a graphical interface 230, a chipset 240, a cache 250 and a network interface 260.

A series voltage regulator in accordance with any one or more of the embodiments described herein may be used to generate intermediate voltages for powering or otherwise controlling one or more circuits in FIG. 8. For example, the series voltage regulator may be included in the power supply or in any of the logic circuits included in ALU 202. In fact, the regulator may be used to generate voltages for any circuit that operates in two or more voltage domains. A circuit of this type may be included in other portions of processor 200, in chipset 240, as well as other depicted elements. Also, it is preferable that the voltage regulator be formed on the same chip as these circuits (e.g., the load). In fact, the entire processing system may be formed on a single chip or die. In alternatively embodiments, one or more elements of the system may reside off-chip, e.g., the power supply generating Vᵢₙ may be located on or off the same die on which the voltage regulator is formed.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

1. A circuit, comprising:
a first voltage regulator; and
a controller to control an output voltage of the first voltage regulator,
wherein the controller operates independently from variations of a load driven by the output voltage of the first voltage regulator.

2. The circuit of claim 1, wherein the first voltage regulator includes a control loop which responds to the load variations to maintain the output voltage at a substantially constant value.

3. The circuit of claim 1, wherein the controller includes:
a second voltage regulator; and
a subtractor to generate an error signal based on a difference between an output voltage of the second voltage regulator and a reference voltage, said error signal controlling the output voltage of the first voltage regulator.

4. The circuit of claim 3, wherein the output voltage of the first voltage regulator equals a predetermined fraction of an input voltage, said predetermined fraction defined by a value of the reference voltage.

5. The circuit of claim 3, wherein the second voltage regulator is a replica of the first voltage regulator.

6. The circuit of claim 5, wherein the first and second voltage regulators are push or pull stages.

7. The circuit of claim 5, wherein the output voltage of the first voltage regulator at least substantially equals the output voltage of the second voltage regulator.

8. The circuit of claim 7, wherein the reference voltage at least substantially equals the output voltages of the first and second voltage regulators.

9. The circuit of claim 3, wherein the error signal controls the output voltage of the second voltage regulator.

10. The circuit of claim 9, further comprising:
a buffer to buffer the error signal prior to input into the second voltage regulator.

11. A circuit, comprising:
first and second voltage regulators;
a first controller to control an output voltage of the first voltage regulator, and
a second controller to control an output voltage of the second voltage regulator,
wherein the first and second controllers operate independently from variations of a load driven by the output voltages of the first and second voltage regulators.

12. The circuit of claim 11, wherein the first voltage regulator is a push stage and the second voltage regulator is a pull stage, and wherein the output voltage of the push stage drives the load when the pull stage is at least substantially off and the output voltage of the pull stage drives the load when the push stage is at least substantially off.

13. The circuit of claim 11, wherein at least one of the first and second voltage regulators includes a control loop which responds to the load variations to maintain a corresponding one of the output voltages at a substantially constant value.

14. A method, comprising:
subtracting an output voltage of a first voltage regulator to a reference voltage; and
controlling an output voltage of a second voltage regulator based on a difference signal generated from the subtraction.

15. The method of claim 14, wherein the first voltage regulator is a replica of the second voltage regulator.

16. The method of claim 14, further comprising:
driving a load circuit based on the output signal of the second voltage regulator.

17. The method of claim 16, wherein the second voltage regulator includes a control loop which responds to load variations to maintain a substantially constant output voltage.

18. The method of claim 16, wherein the output voltage of the first voltage regulator is independent of variations of the load circuit.

19. The method of claim 18, wherein the difference signal maintains the output of the second voltage regulator at a constant value irrespective of the load circuit variations.

20. The method of claim 14, wherein the difference signal controls the output of the second voltage regulator to at least substantially equal the reference voltage.

21. The method of claim 20, further comprising:
controlling the output voltage of the first voltage regulator based on the difference signal, wherein the difference signal controls the output of the first voltage regulator to at least substantially equal the reference voltage.

22. The method of claim 21, further comprising:
buffering the difference signal prior to input into the first voltage regulator.

23. The method of claim 14, wherein the second voltage regulator output equals a predetermined fraction of an input voltage, said predetermined fraction defined by a value of the reference voltage.

24. The method of claim 23, wherein the first voltage regulator output equals the predetermined fraction of the input voltage.

25. The method of claim 14, wherein the first and second voltage regulators are push stages or pull stages.

26. The method of claim 14, further comprising:
subtracting an output voltage of a third voltage regulator to the reference voltage; and
controlling an output voltage of a fourth voltage regulator based on another difference signal generated from subtracting the third voltage regulator output and the reference voltage.

27. The method of claim 26, wherein the third voltage regulator is a replica of the fourth voltage regulator.

28. The method of claim 26, further comprising:
alternately driving a load circuit based on the output voltages of the second and fourth voltage regulators.

29. The method of claim 28, wherein the third voltage regulator output is independent of variations of the load circuit.

30. The method of claim 28, wherein the first and second voltage regulators are push stages and the third and fourth voltage regulators are pull stages.

31. The method of claim 26, wherein the second and fourth voltage regulator outputs at least substantially equal to the reference voltage.

32. The method of claim 31, wherein the reference voltage equals a predetermined fraction of an input voltage of the first, second, third, and fourth voltage regulators.

33. The method of claim 26, further comprising:
controlling the output voltage of the third voltage regulator based on said another difference signal.

34. The method of claim 33, further comprising:
buffering said another difference signal prior to input into the fourth voltage regulator.

35. An integrated circuit die, comprising:
a load;
a first voltage regulator to drive the load; and
a first controller to control a driving voltage from the first voltage regulator,
wherein the first controller operates independently from variations of the load.

36. The circuit of claim 35, wherein the first voltage regulator includes a control loop which responds to the load variations to maintain the output voltage at a substantially constant value.

37. The circuit of claim 35, further comprising:
a second voltage regulator to drive the load; and
a second controller to control the driving voltage from the second voltage regulator,
wherein the second controller operates independently from variations of the load.

38. The circuit of claim 36, wherein the first voltage regulator is a push stage and the second voltage regulator is a pull stage, and wherein the push stage drives the load when the pull stage is at least substantially off and the pull stage drives the load when the push stage is at least substantially off.
